(19) United States
(12) Patent Application Publication
(10) Pub. No.: US 2005/0204139 A1
(43) Pub. Date: Sep. 15, 2005

(54) Service broker security

(76) Inventors: Patrick J. Helland, Bellevue, WA (US); Scott A. Konersmann, Sammamish, WA (US); Matthew Clark McCline, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/797,767

(22) Filed: Mar. 10, 2004

(51) Int. Cl. H04L 9/00

(52) U.S. Cl. 713/171

(57) ABSTRACT

A system and method facilitating the exchange and/or using of a session key (e.g., symmetric key) to facilitate secure communication is provided. The session key can be employed, for example, to encrypt and/or decrypt message(s) that form a dialog between an initiator system and target system(s). “Dialog” refers to bidirectional streams of messages between two endpoints (e.g., initiator system and target system(s)). The systems and methods of the present invention can facilitate, for example, dialog authentication (e.g., ensuring that the initiator and target of the dialog are who they say they are by exchanging security credentials), and, authorization (e.g., only allowing authorized users to send and receive messages). The system(s) and method(s) of the present invention can further facilitate location transparency of service(s) and/or scalable secure monolog(s). The system employs public key/private key asymmetric encryption and/or decryption technique(s) to authenticate and secure information (e.g., message(s) and/or session key(s)) exchanged between an initiator system and a target system.

### TECHNICAL FIELD

The present invention relates generally to computer system(s), and more particularly to systems and methods to facilitate secure exchange of information between service brokers.

### BACKGROUND OF THE INVENTION

Computer network(s) have revolutionalized many aspects of modern life. Businesses are able to connect to one another's computer networks to, for example, retrieve information and/or even store information. However, with this freedom comes risks, such as, the ability of unauthorized user(s) retrieving and/or modifying information stored on a computer network.

Security frameworks have been developed to protect data transmitted in distributed computing systems. Conventional security frameworks have an assortment of degrees of privacy, security, adaptability and scalability. For example, the Kerberos system provides secure communications by users sharing a key with a third party. In order to conduct secure communications, each party connects to the third party and utilizes the key issued by the third party. Among other disadvantages, the Kerberos system allows the third party to track the identities of users who are communicating with each. Furthermore, the third party has the ability to decrypt messages because the third party issues the keys. The Kerberos security model is fixed; that is, administrators have limited flexibility in deployment options.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for system(s) and method(s) facilitating the exchange and use of a session key to facilitate secure communication. A “session key” can be, for example, a symmetric key. The session key can be employed, for example, to encrypt and/or decrypt message(s) that form a dialog between an initiator system and target system(s). “Dialog” refers to a single bidirectional stream of messages between two endpoints (e.g., initiator system and target system(s)). For example, two endpoints can have zero, one or more dialog(s) ongoing at any particular time.

The systems and methods of the present invention can facilitate, for example, dialog authentication (e.g., ensuring that the initiator and target of the dialog are who they say they are by exchanging security credentials), and, authorization (e.g., only allowing authorized users to send and receive messages). The system(s) and method(s) of the present invention can further facilitate location transparency of service(s) and/or scalable secure monolog(s).

In accordance with an aspect of the present invention, a message encryption system is provided. The system employs public key/private key asymmetric encryption technique(s) to authenticate and secure information (e.g., message(s) and/or session key(s)) exchanged between an initiator system and a target system. An initiator of a message has a public key and a private key. Likewise, a target of the message has a public key and a private key.

In order to create a dialog, an initiator of the dialog first securely provides a session key to a target of the message. In one example, the initiator first generates a symmetric session key which is then first encrypted with a private key associated with the initiator. The result of the first encryption is further encrypted with a public key associated with the target. The result of the second encryption is forwarded to the target.

Another aspect of the present invention provides for a message decryption system which employs public key/private key asymmetric decryption technique(s) to authenticate and secure information (e.g., message(s) and/or session key(s)) exchanged between an initiator system and a target system.

For example, the message decryption system can received an encrypted session key and first decrypt it using with a private key associated with the target. The result of the first decryption can be further decrypted with a public key associated with the initiator. The result of the second decryption can be securely stored as a session key associated with a dialog.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a message encryption system in accordance with an aspect of the present invention.

FIG. 2 is a block diagram of a message exchange system in accordance with an aspect of the present invention.

FIG. 3 is a block diagram of a message decryption system in accordance with an aspect of the present invention.

FIG. 4 is a block diagram of a broker services system in accordance with an aspect of the present invention.

FIG. 5 is a block diagram of a broker services system in accordance with an aspect of the present invention

FIG. 6 is a block diagram of an exemplary service broker security system in accordance with an aspect of the present invention.

FIG. 7 is a block diagram of an exemplary dialog authentication structure in accordance with an aspect of the present invention.

FIG. 8 is a block diagram of a delegated handshake system in accordance with an aspect of the present invention.

FIG. 9 is a flow chart of a method facilitating session key encryption in accordance with an aspect of the present invention.

FIG. 10 is a flow chart of a method facilitating session key decryption in accordance with an aspect of the present invention.

FIG. 11 is a flow chart of a method facilitating message encryption in accordance with an aspect of the present invention.

FIG. 12 is a flow chart of a method facilitating message decryption in accordance with an aspect of the present invention.

FIG. 13 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

A “session key” is a symmetric key (e.g., randomly generated by a session key generator 150). The session key can be employed, for example, to encrypt and/or decrypt message(s) that form a dialog between an initiator system and target system(s).

“Dialog” refers to a single bidirectional streams of messages between two endpoints (e.g., initiator system and target system(s)). For example, two endpoints can have zero, one or more dialog(s) ongoing at any particular time. In one example, all messages in a dialog are ordered and dialog messages are always delivered in the order sent. The order is maintained across transactions, across input threads, across output threads, and across crashes and restarts. Further, a “message” can include a conversation handle that uniquely identifies the dialog associated with it. For example, an order entry application can have dialogs open simultaneously with a shipping application, an inventory application and a billing application. Because messages from each application have a unique conversation handle, it's easy to tell which application sent each message.

The systems and methods of the present invention can facilitate, for example:
Dialog Authentication—ensuring that the initiator and target of the dialog are who they say they are by exchanging security credentials.
Authorization—only allowing authorized users to send and receive messages.

The loosely-coupled, asynchronous nature of service broker applications imposes unique requirements on authentication. Dialog(s) may run for extremely long times, connect endpoints in different domains, and transfer messages between applications that come and go throughout the lifetime of the dialog and may never run simultaneously. If dialogs are using store-and-forward routing to transfer messages, there may be no direct network connection between the source and destination for a message. These characteristics of dialogs don't fit within the capabilities of connection-oriented authentication methods (e.g., NTLM and/or Kerberos).

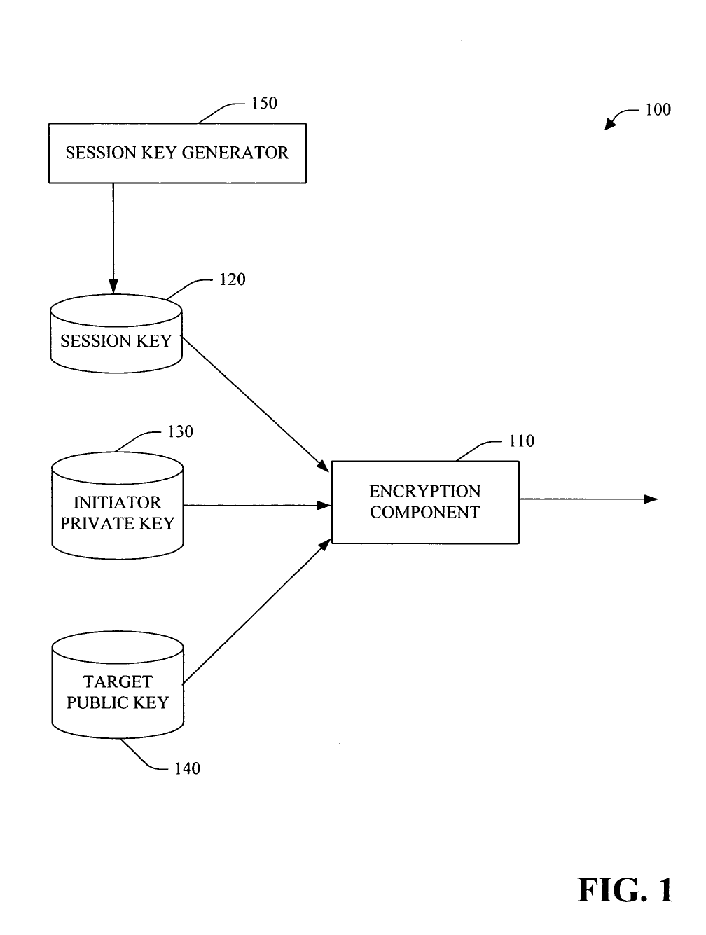

Referring to FIG. 1, a message encryption system 100 in accordance with an aspect of the present invention is illustrated. The system 100 employs public key/private key asymmetric encryption technique(s) to authenticate and secure information (e.g., message(s) and/or session key(s)) exchanged between an initiator system (not shown) and a target system (not shown).

For example, the message encryption system 100 can be employed as part of a service broker that facilitates:

Location Transparency of services: An application (e.g., target system) that utilizes a service is completely isolated from 1) where the service (e.g., initiator system) is physically located and 2) the number of instances of the service that is deployed; and/or

Scalable Secure Monolog: In a publish/subscribe monolog scenario, usually the load on the publisher (e.g., initiator system) increases linearly with the number of subscriber(s) (e.g., target system(s)). This does not allow the number of subscribers to scale very well. Thus, in accordance with an aspect of the present invention, the system 100 can be employed to support scalable secure monolog via:
Distributed Handshake: Fan-out tree of intermediaries that act on behalf of the Publisher to perform the handshake with a subset of the subscribers.

Asymmetric Encryption

Asymmetric encryption involves two digital keys—a public key and a private key. These keys have the useful property that something encrypted with the public key can only be decrypted with the private key and something encrypted with the private key can only be decrypted with the public key. As the names imply, the private key is a closely guarded secret that must be protected and the public key can be distributed to anybody.

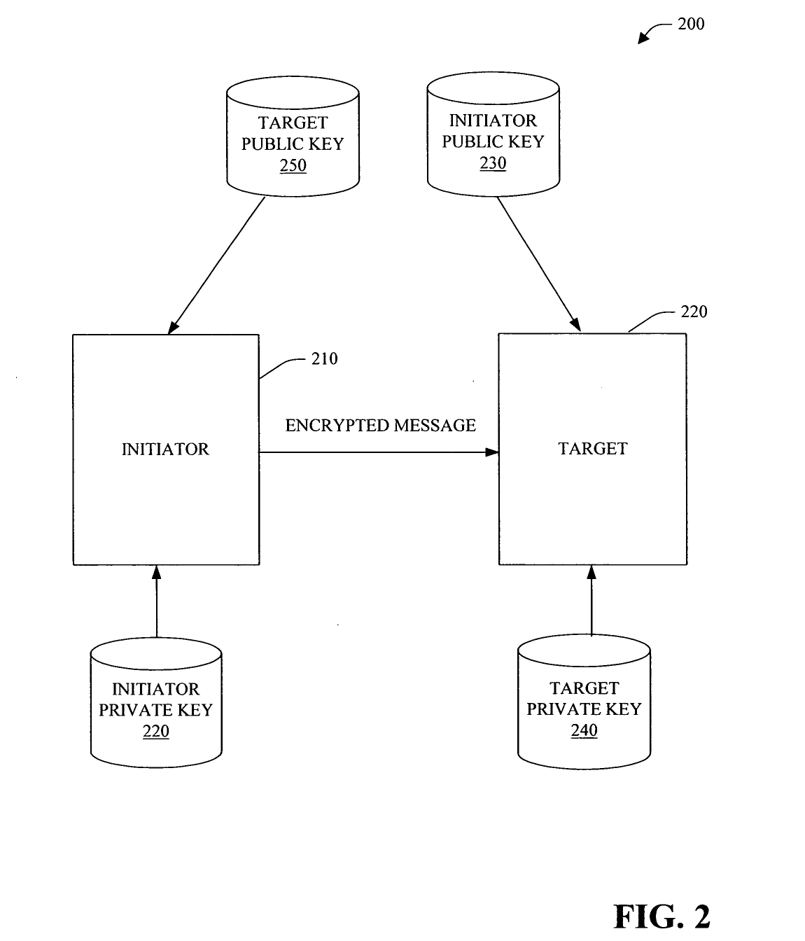

Referring briefly to FIG. 2, a message exchange system 200 in accordance with an aspect of the present invention is illustrated. The system 200 facilitates message exchange between an initiator 210 and a target 220. The initiator 210 and the target 220 desire to establish trusted communications between themselves (e.g., to authenticate user's identities).

In this example, the initiator 210 creates a public-key/private-key pair, for example, an initiator public key 230 and an initiator private key 240. The initiator 210 keeps the initiator private key 240 private and provides the initiator public key 230 to the target 220. Similarly, the target 220 creates a public-key/private-key pair, for example, a target public key 250 and a target private key 260. The target 220 keeps the target private key 260 private and provides the target public key 250 to the initiator 210.

Providing of the initiator public key 230 can be done securely so that the target 210 knows that the initiator public key 230 is from the initiator 210 (e.g., and vice-versa). The secure exchange of public key(s) can be done in any suitable manner. Once this exchange occurs, the keys can be employed to authenticate message exchange(s) between the initiator 210 and the target 220.

For example, the target keys 250, 260 and the initiator keys 230, 340 can be employed to securely transfer a session key (not shown).

Message Encryption System 100

Referring back to FIG. 1, the message encryption system 100 includes an encryption component 110 that employs asymmetric encryption to authenticate and encrypt a message. For example, the encryption component 110 can encrypt a session key 120 using an initiator private key 130 and a target public key 140. In one example, the session key 120 is a 128-bit symmetric key.

For example, the session key generator 150 can generate the session key 120 (e.g., randomly generated 128-bit symmetric key). The encryption component 110 can encrypt the session key 120 using the initiator's private key 130. Thereafter, the encryption component 110 can further encrypt the result of this first encryption with a target public key 140. The encryption component 110 can then provide this second encryption result as a message.

In another example, the session key 120 is separately encrypted with the target public key 140. In this example, the twice encrypted session key (as discussed above) and the separately encrypted session key are sent to the target, for example, to establish authenticity of the session key 120.

It is to be appreciated that the message encryption system 100, the encryption component 110, the session key 120, the initiator private key 130, the target public key 140 and/or the session key generator 150 can be computer components as that term is defined herein.

Message Decryption System 300

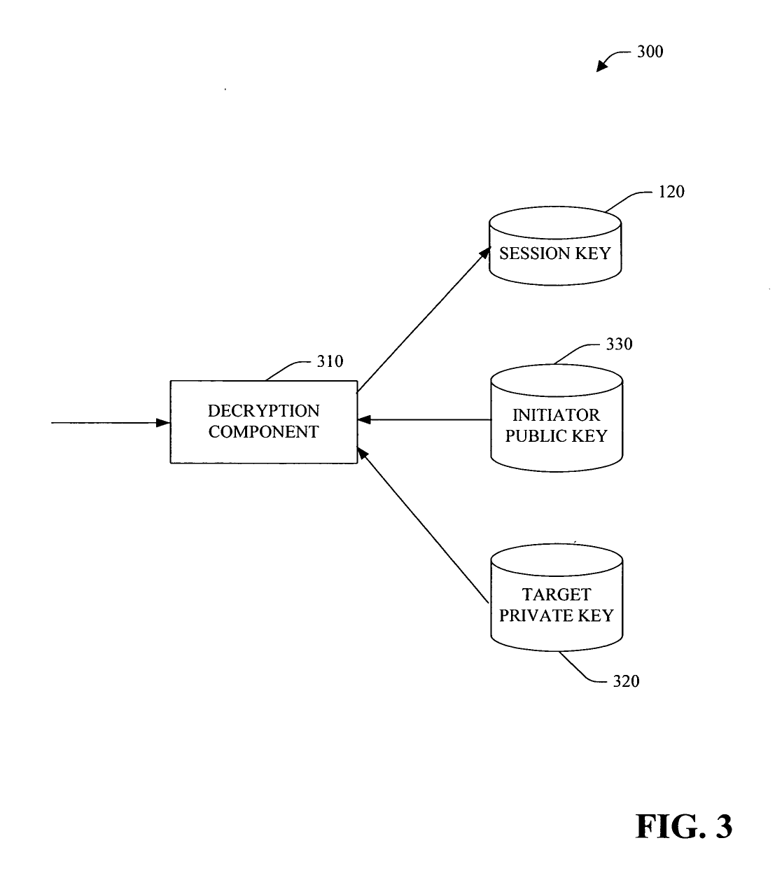

Turning to FIG. 3, a message decryption system 300 in accordance with an aspect of the present invention is illustrated. For example, the system 300 can receive the second encryption result message from the encryption component 110.

The system 300 includes a decryption component 310 that employs a target private key 320 and an initiator public key 330 to authenticate and decrypt the session key 120.

For example, the decryption component 310 can receive an encrypted message (e.g., from an encryption component 110). The decryption component 310 can employ the target private key 320 to decrypt the message. This first decryption result can further be decrypted using the initiator public key 330. In one example, the result of this second decryption is the session key 120. The decryption component 310 can store the session key 120 for use in exchanging message(s) with service broker system(s) (e.g., initiator).

Because both the initiator's and the target's keys (private key and public key) are used to transfer the symmetric session key, the target can be sure the symmetric key is from the initiator (if it were not, the initiator public key wouldn't have decrypted it) and the initiator can be sure the message came from the target (if not, the target couldn't have decrypted the symmetric key that was encrypted with the target public key).

As noted previously, the session key encryption system 100 and the session key decryption system 300 can be employed as part of a service broker that facilitates location transparency of services and/or scalable secure monolog.

It is to be appreciated that the message decryption system 300, the decryption component 310, the target private key 320 and/or the initiator public key 330 can be computer components as that term is defined herein.

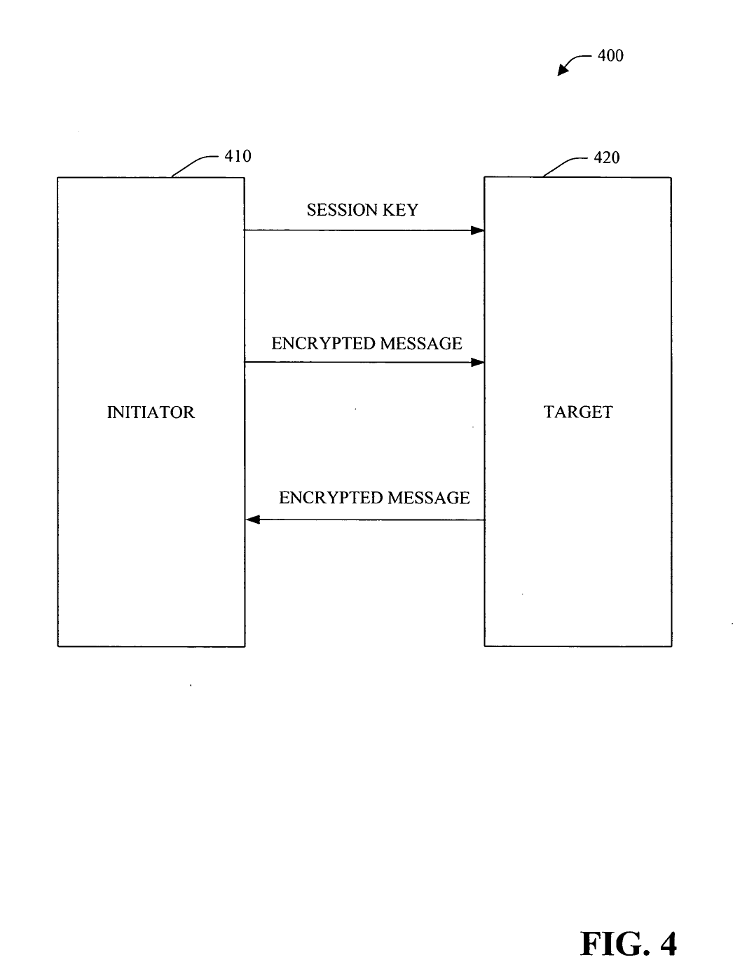

Turning next to FIG. 4, a broker services system 400 in accordance with an aspect of the present invention is illustrated. The system 400 includes an initiator 410 and a target 420. The initiator 410 generates and encrypts a session key. The encrypted session key is then provided to the target 420.

The target 420 decrypts and stores the session key which used to encrypt and/or decrypt messages exchanged with the initiator 410.

It is to be appreciated that the broker services system 400, the initiator 410 and/or the target 420 can be computer components as that term is defined herein.

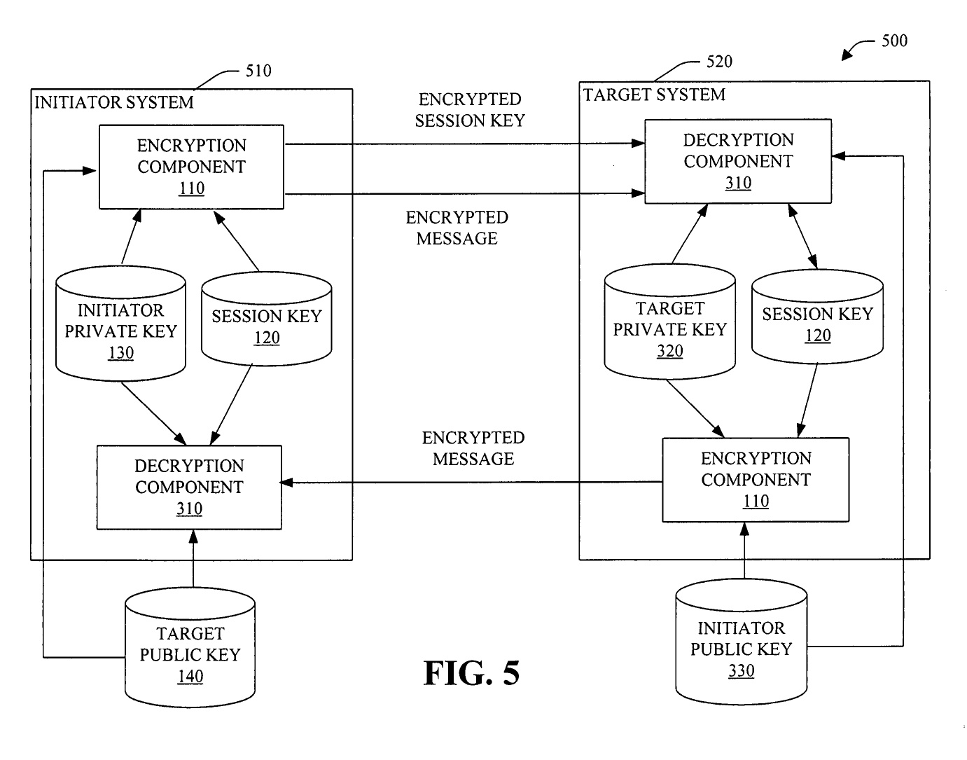

Referring to FIG. 5, a broker services system 500 in accordance with an aspect of the present invention is illustrated. The system 500 includes an initiator system 510 and a target system 520.

The initiator system 510 includes an encryption component 110 and a decryption component 310. The initiator system 510 has secure access to an initiator private key 130 and a session key 120. Further, the initiator system 510 has access to a target public key 140.

The target system 520 includes an encryption component 110 and a decryption component 310. The target system 520 has secure access to a target private key 320. Further, the target system 520 has access to an initiator public key 330.

As discussed previously, the encryption component 110 of the initiator system 510 encrypts the session key 120 with the initiator private key 130. The result of this first encryption is further encrypted with the target public key 140. The result of this second encryption is provided to the target system 520 (e.g., encrypted session key).

The decryption component 310 of the target system 520 receives the encrypted session key and decrypts it with the target private key 320. The result of this first decryption is further decrypted with the initiator public key 330. The result of the second decryption is the session key 120 which can be securely stored by the target system 520.

Thereafter, the initiator system 510 and the target system 520 can engaged in a dialog employing message(s) encrypted with the session key 120. In order to facilitate authenticity of the sending entity, the message(s) encrypted with the session key 120 can further be signed with the initiator private key 130.

It is to be appreciated that the broker services system 500, the initiator system 510 and/or the target system 520 can be computer components as that term is defined herein.

Overall Service Broker Security System

Those skilled in the art will recognize that the session key encryption system 100, the session key decryption system 200, the broker services system 400 and/or the broker services system 500 can be component(s) of an overall service broker security system.

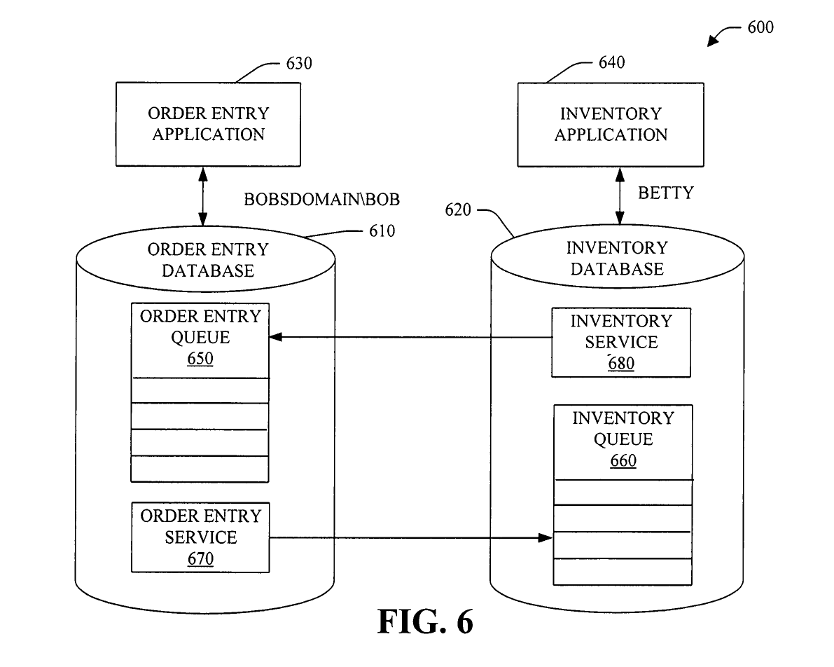

Turning next to FIG. 6, an exemplary service broker security system 600 in accordance with an aspect of the present invention is illustrated. In one example, there are three aspects to configuring service broker security:
Dialog Security—setting up certificates for authentication.
Authorization—setting up permissions on queues.
Transport security—setting up user authentication for the TCP/IP connections

The example illustrated in FIG. 6 includes an order entry database 610 (e.g., “BOB”) and an inventory database 620 (e.g., BETTY). For example, an order entry application 630 running on Bob's SQL Server can talk to an inventory application 640 running on Betty's SQL Server. For the sake of this example, assume that both applications are C# programs using ADO.Net to talk to the databases 610, 620. Bob's order entry application 630 connects to the order entry database 610 using integrated authentication with a user name of BOBSDOMAIN\BOB and Betty's inventory application 640 connects to the inventory database 620 using SQL Sever authentication with a user name of BETTY.

At discussed earlier, in accordance with an aspect of the present invention, authentication requires two keys at each end of the connection. Bob needs his private key and Betty's public key while Betty needs her private key and Bob's public key. In one example, a convenient way to store public keys is to allow digital certificates to be stored in the database. The system 600 can take advantage of this by using these certificates to authenticate dialog users.

For example, certificate(s) can be owned by database login principals. For the system 600 to associate a database user with a certificate it navigates to the login for that user and then to the certificate.

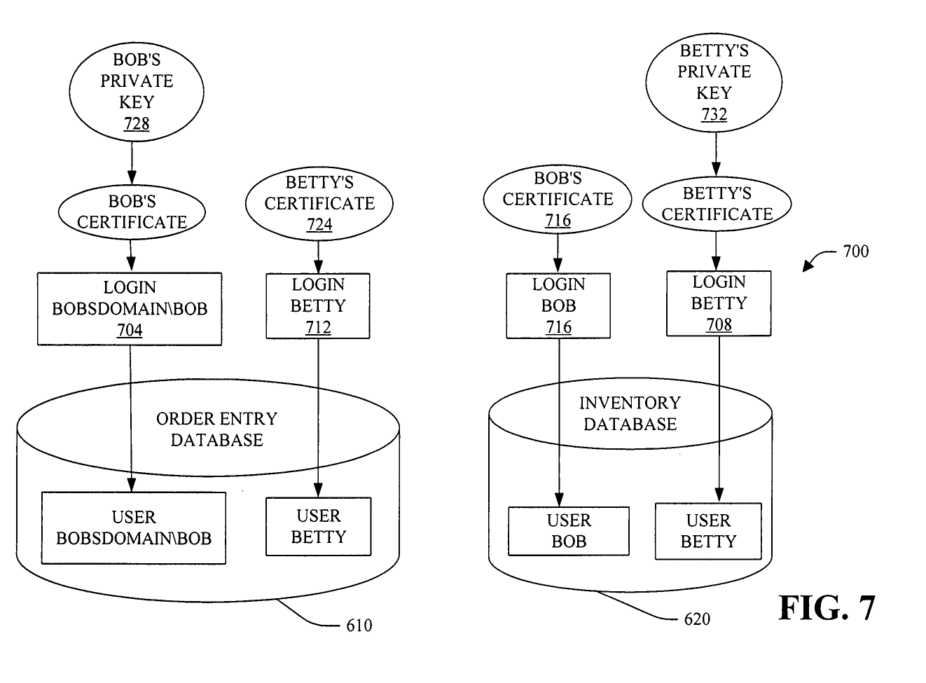

Referring briefly to FIG. 7, an exemplary dialog authentication structure 700 in accordance with an aspect of the present invention is illustrated.

Creating Logins

For purposes of explanation it is assumed that Bob and Betty have logins to their own databases, for example, LOGIN BOBSDOMAIN\BOB 704 and LOGIN BETTY 708, respectively. It can further be assumed that Bob and Betty don't want to allow each other to login directly to their databases so SQL Server logins with random passwords can be created. If Betty already has a login in Bob's server, this can also be used.

For example, Bob's database application (e.g., order entry application 630) can run the following command on the OrderEntry server to create LOGIN BETTY 712:

Create Login Betty With Password=‘AHENDDKJHSUYNE**&834’;

Similarly, Betty's database application (e.g., inventory application 640) can run the following command on the Inventory server to create LOGIN BOB 716:

Create Login Bob With Password=‘JJDHWYS((7736’;

In one example, dummy login(s) which represent the service broker service itself rather than a real user can be employed. For example, logins “OEUser” can be created in the inventory server and “InvUser” can be created in the order entry server. This can reduce the number of logins that have to be created and managed for dialog security.

Creating Users

Database user(s) are created in the databases where the Service Broker queues exist, for example, order entry queue 650 and inventory queue 660. In one example, users are required because queue access privileges must be granted to database users.

Bob's database application (e.g., order entry application 630) can run the following commands on the OrderEntry server 610:

Use OEDB

Create User BOBSDOMAIN\BOB For Login BOBSDOMAIN\BOB

Create User Betty For Login Betty

Similarly, Betty's database application (e.g., inventory application 640) can run the following command on the Inventory server 620:

Use InvDB

Create User Bob For Login Bob

Create User Betty For Login Betty

Creating Certificates

In one example, dialog security uses the keys associated with certificates for authentication. In this example, it does not do certificate authority checks on the validity of certificates. It assumes that the database application (e.g., order entry application 630 and inventory application 640) put valid certificates into the database.

In order to facilitate establishment of a dialog, Bob and Betty must exchange their certificate files, for example, BOB'S CERTIFICATE 720 and BETTY'S CERTIFICATE 724 (e.g., but NOT their private keys, BOB'S PRIVATE KEY 728 AND BETTY'S PRIVATE KEY 732, respectively). The exchange can be accomplished by any suitable secure technique, for example, secure email, a commonly accessed shared resource and the like.

Once the certificates and keys have been created and exchanged, they can be loaded into SQL Server.

Bob's database application (e.g., order entry application 630) can run the following commands on the order entry server 610:

Create Certificate BobsCert

AUTHORIZATION [BOBSDOMAIN\BOB]

From ‘C:\BobsCert.cer’

With Private_key=‘C:\BobsKey.pvk’

Password=‘xxxxx’

Create Certificate BettysCert

AUTHORIZATION [Betty]

From ‘C:\BettysCert.cer’

In this example, the Password is the password that protects the private key (e.g., password entered when makecert.exe was run).

Betty's database application (e.g., inventory application 640) can run the following command on the inventory server 620:

Create Certificate BettysCert

AUTHORIZATION [Betty]

From ‘C:\BettysCert.cer’

With Private_key=‘C:\BettysKey.pvk’

Password=‘xxxxx’

Create Certificate BobsCert

AUTHORIZATION [Bob]

From ‘C:\BobsCert.cer’

Again, the Password is the password that protects the private key (e.g., the password entered when makecert.exe was run). In this example, the Authorization clause assigns ownership of the certificate to the specified login.

Creating Remote Service Bindings

When the order entry application 630 begins a dialog to the inventory application 640, it will use the certificate of the user running the application for the private key required for authentication. To determine which certificate to use for the public key, the Service Broker must know which certificate is associated with the “To Service” clause of the Begin Dialog command. This is specified by creating a remote service binding.

To create the Remote Service Binding, Bob's database application (e.g., order entry application 630) can run the following:

Create Remote Service Binding InventoryBinding

To Service ‘//betty.com/Inv/InventoryService’

With (User=[Betty])

This command indicates that whenever a dialog is started with //betty.com/Inv/InventoryService in the “To Service” parameter, Betty's public key will be used to authenticate the connection.

Only the dialog initiator needs to have a remote service binding specified so Betty's database application (e.g., inventory application 640) doesn't have to do anything for this dialog.

Granting Permissions

To establish the dialog, Bob must be able to Receive from the order entry queue 650 and send to an Inventory service 680 while Betty must be able to Receive from the inventory queue 660 and send to an Order Entry service 670. For example, Send and Receive permissions can be used to grant access to Service Broker queues.

To establish permissions, Bob's database application (e.g., order entry application 630) can configure the following permissions:

Use Order Entry Database

Grant Receive on order entry queue to [BOBSDOMAIN\BOB]

Grant send on SERVICE::[//Bob.com/OE/OrderEntryService] to [Betty]

This means that Bob can receive messages from the Order Entry queue 650 and Betty can use the Order Entry service 670 to send messages to the Order Entry queue 650.

Betty's database application (e.g., inventory application 640) can configure the following permissions:

Use Inventory Database

Grant Receive on Inventory Queue to [Betty]

Grant send on SERVICE::[//Betty.com/Inv/InventoryService] to [Bob]

This means that Betty can receive messages from the Inventory queue 630 and Bob can use the Inventory service 680 to send messages to the Inventory queue 630.

It is to be appreciated that the system 600, the order entry database 610, the inventory database 620, the order entry application 630, the inventory application 640, the order entry queue 650, the inventory queue 660, the order entry service 670, the inventory service 680, the system 700 can be computer components as that term is defined herein.

Location Transparency of Services

By allowing service(s) to be addressed logically by name, the system(s) and method(s) of the present invention allow application(s) to be built independent of where the service is located physically. At deployment time, the service(s) can be moved to different physical location(s) without affecting the application. The application can also take advantage of any additionally deployed instances of the service dynamically at run time.

Referring to the examples discussed above, as long as Betty (e.g., target) and Bob (e.g., initiator) has a copy of each other's public key and granted each other the appropriate permissions to send to the services they own, they will be able to exchange message(s) regardless of where the services are actually located. For example, Bob could move his Order Entry Service 670 to another physical machine, and Betty can still be able to talk to the service without any changes to her application.

If at some point in time, the message load on the Order Entry Service 670 increases significantly, Bob may wish to deploy additional instances of the Order Entry Service 670, either on another database in the same machine or on a completely different machine. Betty can be able to take advantage of these additional instances without any modification to her application as long as the right Remote Service Binding is configured to utilize the additional services.

In one example, instances of the same service can share the same private key; this allows outside services that wish to communicate with these services to treat them collectively as a unit and obviates the need to create additional Remote Service Bindings.

Thus, the system(s) and method(s) of the present invention, and, more specifically the use of public key encryption allows for dynamic 1) redeployment of services and 2) load balancing.

Scalable Secure Monolog

Conventional system(s) do not reliably support publish-subscribe. Existing products use a best-effort approach to deliver the messages to the subscribers only. Also, no existing product is able to ensure the security of message(s) from end to end.

The system(s) and method(s) of the present invention can support reliable publish-subscribe. Further, secure end-to-end transfer of message(s) via public key encryption is further supported as discussed above. Additionally, “distributed handshake” and/or “shared session key” as discussed below can be employed, for example, for scalability and/or performance (e.g., to lessen the load on the publisher (initiator)).

As discussed previously, generally only two parties share a single session key 120, otherwise, when a message arrives encrypted with the key, the identity of the sender of the message cannot be ascertained.

In one example, each service is a single party, regardless of the number of instances of that service. This can be accomplished, for example, by distributing the same private key for that service to the deployed instances of the service.

However, in a monolog scenario, where you have one service that acts as a publisher (e.g., initiator) that publishes the same message to a plurality of subscriber services (e.g., target), for example, tens of thousands of subscriber services, it is not feasible to have the publisher perform the security handshake process to exchange a unique session key with each subscriber. The handshake process can be resource expensive. Further, this solution will not allow the publisher to talk to more than a handful of subscribers if reasonable performance is expected.

Two criterions can be considered in this scenario:
1. The subscriber must be sure that a message sent on the monolog indeed came from the publisher. That is, the subscriber must be able to reject any message from a third party pretending to be the publisher.
2. The solution must scale very well.

The system(s) and method(s) of the present invention can facilitate two solutions to secure monologs that satisfy both of these criterions: (1) delegate handshake; and, (2) off-loaded session key.

Delegated Handshake

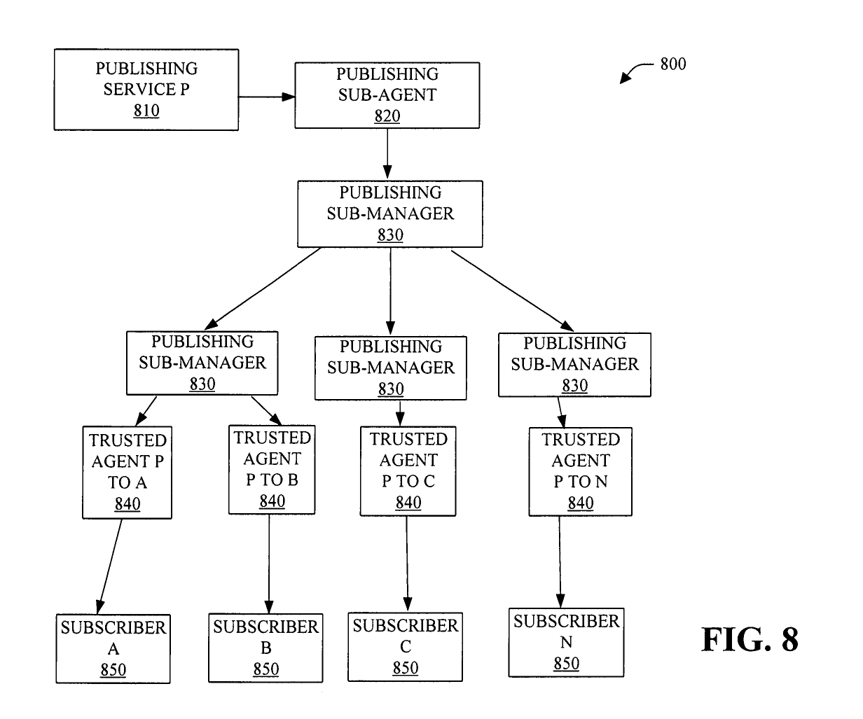

Turning briefly to FIG. 8, a delegated handshake system 800 in accordance with an aspect of the present invention is illustrated. The system 800 includes a publishing service P 810, a publishing sub-agent 820, a plurality of publishing sub-managers 830 and a plurality of trusted agents 840.

As illustrated in FIG. 8, instead of having a single publisher responsible for performing the handshake process with each subscriber, the system 800 can deploy a fan out tree of trusted agents 840 that can act on its behalf to perform the handshake process with a subset of the subscribers 850. These trusted agents can share the same private key as the publisher service P 810, so from the point of view of the subscriber(s) 850, they are no different from the actual publisher service P 810 hence no changes need to be made at the subscriber 850 side. As the number of subscriber 850 increases, additional trusted agents 840 can be deployed to share the load.

In another example, the trusted agents 840 can negotiate a unique session key with each of the subscriber(s) 850 (e.g., publisher service P 810 delegated authority for negotiating session key to trusted agents 840).

It is to be appreciated that the system 800, the publishing service P 810, the publishing sub-agent 820, the publishing sub-manager 830, the trusted agents 840 and/or the subscribers 850 can be computer components as that term is defined herein.

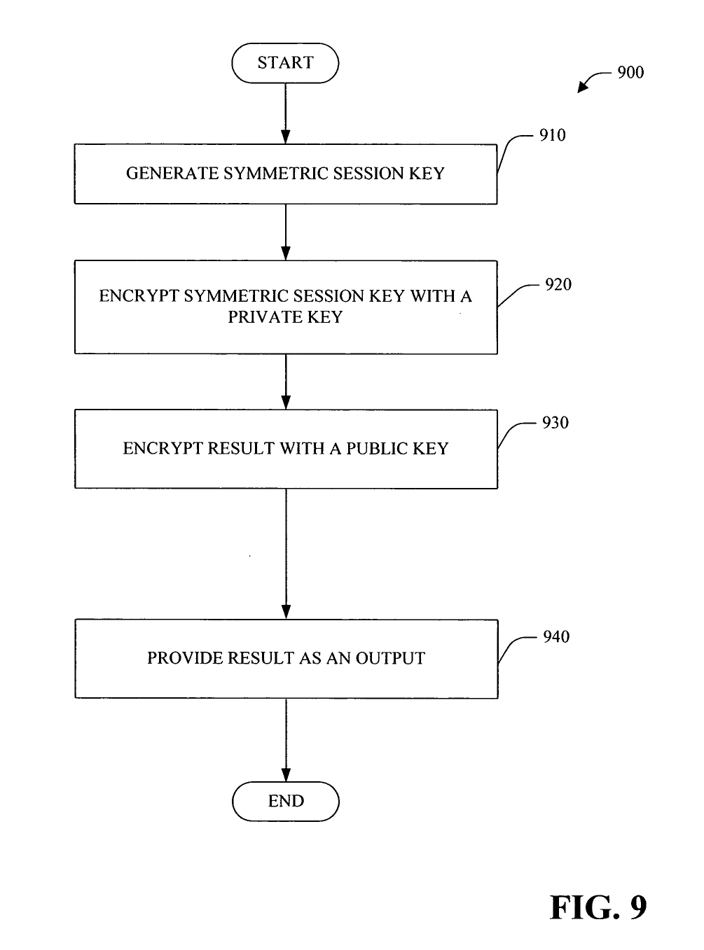

Turning briefly to FIGS. 9, 10, 11 and 12, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 9, a method facilitating session key encryption 900 in accordance with an aspect of the present invention is illustrated. At 910, a symmetric session key is generated. At 920, the session key is encrypted with a private key (e.g., initiator private key 130). At 930, the result of the first encryption is encrypted with a public key (e.g., target public key 140). The result of the second encryption is provided as an output.

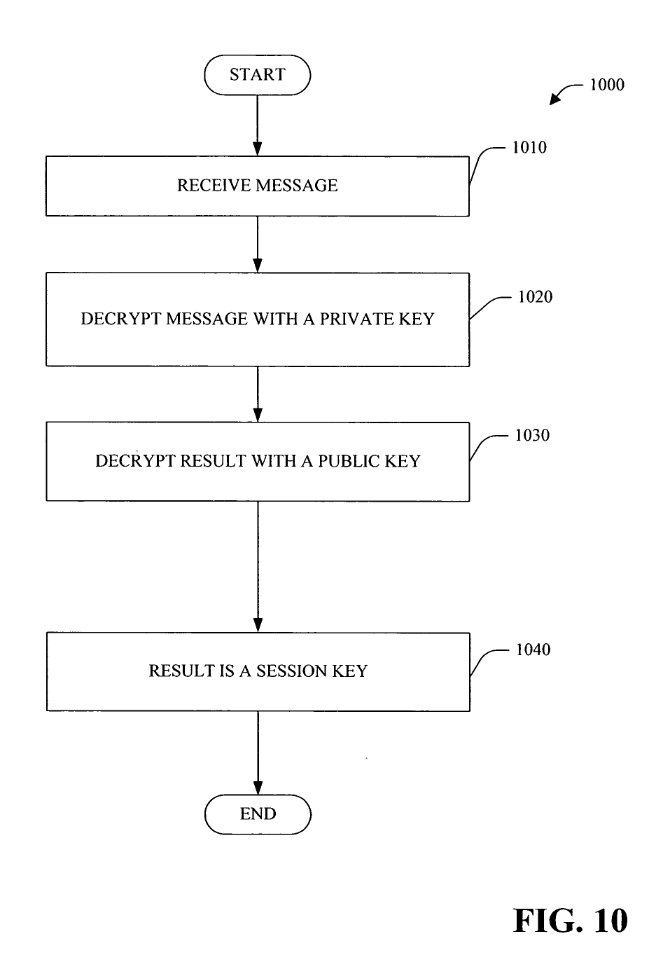

Turning to FIG. 10, a method facilitating session key decryption 1000 in accordance with an aspect of the present invention is illustrated. At 1010, a message is received. At 1020, the message is decrypted with a private key (e.g., target private key 320). At 1030, the result of the first decryption is further decrypted with a public key (e.g., initiator public key 330). The result of the second decryption is a session key to be employed, for example, in a dialog exchange between an initiator and a target.

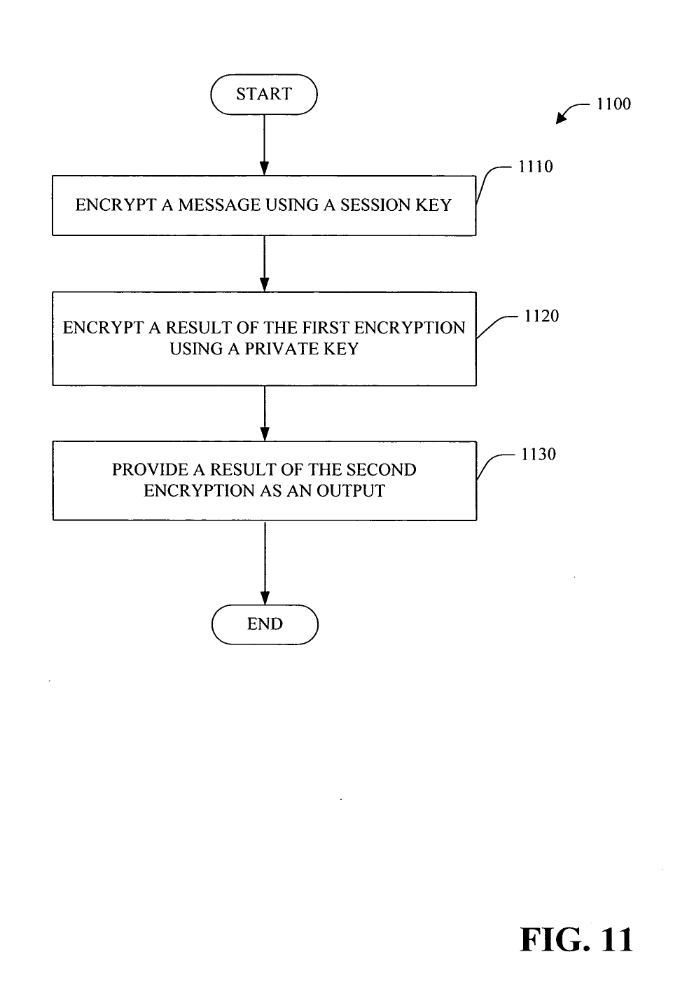

Next, referring to FIG. 11, a method facilitating message encryption 1100 in accordance with an aspect of the present invention is illustrated. At 1110, a message is encrypted using a session key. At 1120, a result of the first encryption is encrypted using a private key (e.g., signed for authenticity). At 1130, a result of the second encryption is provided as an output (e.g., encrypted message).

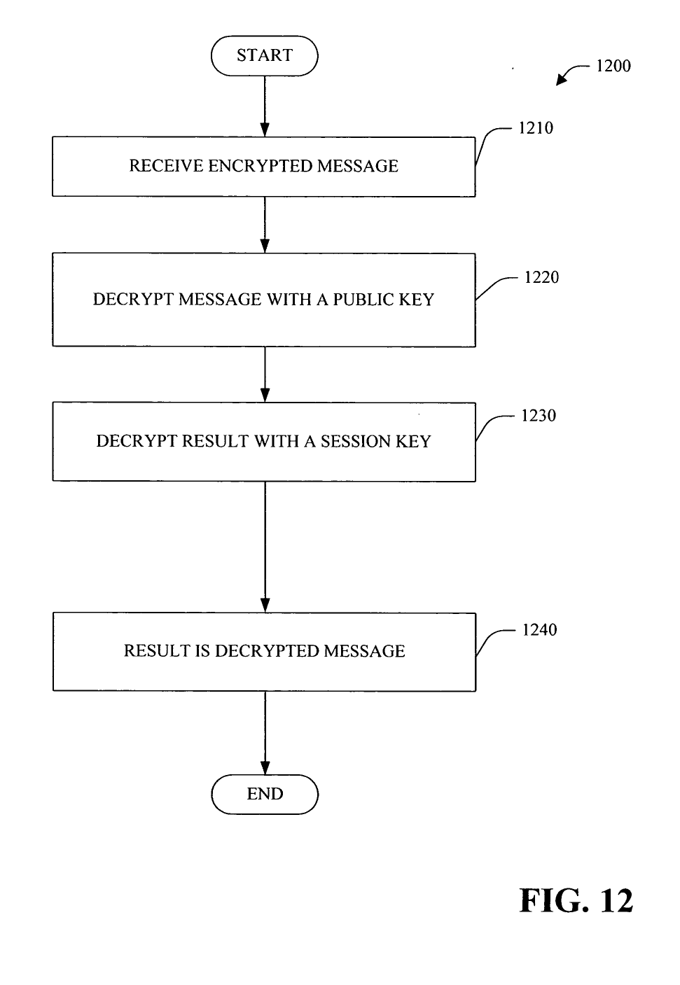

Turning to FIG. 12, a method facilitating message decryption 1200 in accordance with an aspect of the present invention is illustrated. At 1210, an encrypted message is received. At 1220, the encrypted message is first decrypted with a public key (e.g., associated with a sender of the encrypted message). At 1230, a result of the first decrypted is further decrypted using a session key. At 1240, the result of the second decryption is the decrypted message.

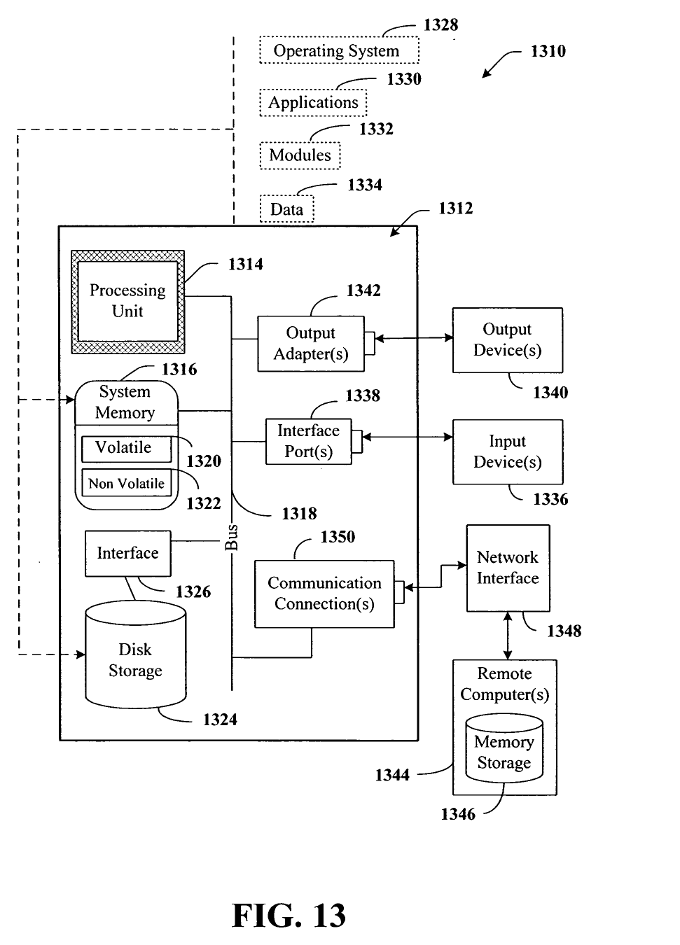

In order to provide additional context for various aspects of the present invention, FIG. 13 and the following discussion are intended to provide a brief, general description of a suitable operating environment 1310 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1310 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 13, an exemplary environment 1310 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/nonremovable, volatile/nonvolatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A message encryption system comprising:
a session key employed to securely exchange a message associated with a dialog; and,
an encryption component that employs asymmetric encryption to first securely transmit the session key, the session key thereafter being employed to encrypt the message and securely exchange the message.

2. The system of claim 1, the session key comprising a 128-bit randomly generated symmetric key.

3. The system of claim 1, the encryption component first encrypts the session key employing a private key, the encryption component further encrypts the result of the first encryption employing a public key.

4. The system of claim 3, the private key being securely associated with an initiator of the message.

5. The system of claim 3, the public key being associated with a target of the message.

6. The system of claim 3, further comprising a plurality of trusted agents that act as a proxy for a publisher to respectively exchange the message with respective subscribers, the trusted agents employing the private key.

7. The system of claim 6, a trusted agent negotiates a unique session key with a subscriber

8. The system of claim 6, the trusted agents acting in concert to dynamically load balance distribution for the publisher.

9. The system of claim 3, the public key being stored as a digital certificate.

10. The system of claim 9, the digital certificate being associated with a user via a login protocol.

11. The system of claim 1, the encryption component first encrypts the session key employing a private key, the encryption component further encrypts the result of the first encryption employing a public key, and, the encryption component separately encrypts the session key with a public key, the result of the second encryption and the separate encryption provided as an output.

12. The system of claim 1, the encryption component further encrypting the message with a private key.

13. A broker security system employing the session key of claim 1.

14. A message decryption system comprising:
a session key employed to securely exchange a message associated with a dialog; and,
a decryption component that employs asymmetric decryption to first securely decrypt the session key, the session key thereafter being employed to decrypt the message.

15. The system of claim 14, the decryption component first decrypts a message with a private key, the decryption component further decrypting the result of the first decryption with a public key, the result of the second decryption is the session key.

16. The system of claim 15, the private key being securely associated with a target of the message.

17. The system of claim 16, the public key being associated with an initiator of the message.

18. A method facilitating session key encryption comprising:
firstly encrypting a symmetric session key with a private key;
secondly encrypting a result of the first encryption with a public key; and,
providing a result of the second encryption as an output.

19. The method of claim 18, the private key being associated with an initiator of a message.

20. The method of claim 18, the public key being associated with a target of a message.

21. A computer readable medium having stored thereon computer executable instructions for carrying out the method of claim 18.

22. A method facilitating session key decryption comprising:
firstly decrypting a message with a private key;
second decrypting a result of the first decryption with a public key; and,
employing a result of the second decryption as a session key.

23. The method of claim 22, the private key being associated with a target of a message.

24. The method of claim 22, the public key being associated with an initiator of a message.

25. A computer readable medium having stored thereon computer executable instructions for carrying out the method of claim 22.

26. A data packet transmitted between two or more computer components that facilitates secure distributed communication, the data packet comprising:
a data field comprising an encrypted message, the encrypted message first encrypted with a symmetric session

27. A message decryption system comprising:
means for receiving an encrypted session key;
means for decrypting the encrypted session key using a private key;
means for decrypting a result of the first decryption with a public key;
means for securely storing a result of the second decryption as a session key; and,
means for employing the session key to decrypt a message.
